(19) United States
(12) Patent Application Publication
(10) Pub. No.: US 2025/0030576 A1
(43) Pub. Date: Jan. 23, 2025

(54) LAYERED FAIL-SAFE REDUNDANCY ARCHITECTURE AND PROCESS FOR USE BY SINGLE DATA BUS MOBILE DEVICE

(71) Applicant: Tomahawk Robotics, Inc., Melbourne, FL (US)

(72) Inventors: William S. BOWMAN, Melbourne, FL (US); Andrew D. FALENDYSZ, Grant, FL (US); Kevin M. MAKOVY, West Melbourne, FL (US); Matthew D. SUMMER, Melbourne, FL (US); Michael E. BOWMAN, Satellite Beach, FL (US); Michael W. HOLT, Smyrna, GA (US); Mark B. MOFFETT, Melbourne, FL (US)

(73) Assignee: Tomahawk Robotics, Inc., Melbourne, FL (US)

(21) Appl. No.: 18/353,866

(22) Filed: Jul. 17, 2023

(51) Int. Cl. H04L 12/40; G05D 1/00

(52) U.S. Cl. CPC H04L 12/40006; H04L 2012/40273

(57) ABSTRACT

Methods and systems are described herein for a layered fail-safe redundancy system and architecture for privileged operation execution. The system may receive vehicle maneuvering commands from a controller over a first channel. When a user input is received to initiate a privileged mode for executing privileged commands, the system may receive a privileged command over a second channel. The system may identify, based on the privileged mode of operation and the privileged command, a privileged operation to be performed by a vehicle. The system may then transmit a request to the vehicle to perform the privileged operation.

### BACKGROUND

Stable and reliable robotic systems are becoming increasingly common. This has contributed to the recent advancement and proliferation of unmanned system technologies, including ground-based systems, aerial-based systems, and/or maritime-based systems. Various control methods are available to control unmanned systems, which are sometimes referred to as unmanned vehicles. Some unmanned vehicles enable a user to execute privileged commands (e.g., munition commands). Although privileged commands are required in certain situations, it is important that those commands are not executed inadvertently (e.g., due to operator error or software error).

### SUMMARY

Therefore, methods and systems are described herein for a layered fail-safe redundancy system and architecture for privileged operation execution. A command execution system may be used to perform operations described herein. The command execution system may reside on a mobile device that may be connected with the vehicle controller, for example, via a physical connection such as a universal serial bus (USB) connection. The physical connection may have a plurality of channels. For example, a USB connection may be enabled to connect over different interfaces corresponding to different channels. This architecture enables privileged commands (e.g., munitions commands, destruct commands, payload release commands, etc.) to be initiated over one channel and completed over another channel, thereby preventing inadvertent execution, whether due to operator error or software error.

In some embodiments, the command execution system may receive commands from a vehicle controller, process those commands (e.g., translate them into commands that a vehicle is able to execute), and transmit those commands to the vehicle (e.g., over a radio signal or another suitable signal). For example, the command execution system may receive, from a vehicle controller over a first channel, a vehicle maneuvering command. As discussed above, the command execution system may reside on a mobile device that is connected with the vehicle controller over a physical connection having the first channel and a second channel. That is, regular vehicle operation/maneuvering commands may be received over the first channel (e.g., using a first interface). The command execution system may transmit the vehicle maneuvering command to a vehicle (e.g., to an unmanned vehicle) for execution. For example, the command execution system may receive a command from the vehicle controller to maneuver an aerial vehicle forward. The command execution system may translate that command into a particular propeller operation and send the command to the vehicle (e.g., over a radio broadcast, a cellular connection, or another suitable connection).

The command execution system may continue to process maneuvering commands for the vehicle until a privileged operation is required. Thus, the command execution system may receive, using an input mechanism associated with the mobile device, a first privileged command. For example, the first privileged command may be an operator dragging a slider on the mobile device (e.g., a touch screen showing an interactive slider image). In another example, the first privileged command may be a particular gesture or a combination of touches on a touch screen.

In some embodiments, the command execution system may determine that the first privileged command (e.g., first munitions command) corresponds to a first input in a sequence of inputs for executing a privileged operation (e.g., a munitions operation). For example, the slider may be a first input in a sequence required to initiate a firing command from an unmanned vehicle. The sequence may be indicated by the slider (or another suitable input on the mobile device) in combination with inputs from a vehicle controller. In another example, the privileged command may be a command to release a payload (e.g., being held using magnetic force). The payload may be a heavy object that may be a danger to people and objects. Thus, releasing the payload may be a privileged operation.

The command execution system may then initiate/enable a privileged mode of operation. In some embodiments, the command execution system may, based on receiving the first privileged command, initiate a privileged mode of operation such that the privileged mode of operation enables privileged operations using the vehicle controller. For example, the privileged operation mode may enable a munitions command for firing a weapon coupled with a vehicle. In another example, the privileged operation mode may enable a destruct command or another type of command that requires a robust fail-safe mechanism.

In some embodiments, the command execution system may enable the privileged mode of operation by initializing a monitoring of a second channel so that the rest of the sequence required to initiate a firing command may be received over that second channel. For example, the command execution system may, based on determining that the first privileged command (e.g., the first munitions command) corresponds to the first input in the sequence of inputs for executing the privileged operation (e.g., munitions operation), monitor the second channel for a second privileged command (e.g., the second munitions command) from the vehicle controller. Thus, the command execution system may monitor the second channel for an input or a combination of inputs from the vehicle controller that instruct the vehicle to fire an onboard weapon or one of its onboard weapons.

As the command execution system monitors the second channel, the command execution system may receive a second privileged command from the vehicle controller over the second channel. For example, the second privileged command may be a single button press or a combination of buttons pressed on the vehicle controller. In some embodiments, the second privileged command may be a combination of buttons pressed followed by a single button press. In yet some embodiments, the privileged command may be a combination button press, followed by a single button press while the original combination of buttons continues being pressed.

In some embodiments, the privileged mode may only be enabled for a predetermined period of time (e.g., 15 seconds, 30 seconds, 1 minute, etc.). That is, to prevent accidental execution of privileged operation, if the input sequence is not completed timely, the command execution system may disable the privileged mode of operation. Thus, in some embodiments, the command sequence will need to be restarted from the first privileged operation.

In some embodiments, the privileged mode may be disabled if a wrong command is input as the second privileged command. For example, when the command execution system enters the privileged mode, the command execution system may receive the second execution command that includes a combination and/or sequence of inputs. If that combination and/or sequence of inputs does not match a privileged operation, the command execution system may disable the privileged mode. In some embodiments, the command execution system may prompt the user to input the first privileged command to initiate the privileged mode.

The command execution system may determine that the second privileged command corresponds to a second input in a sequence of inputs for executing a privileged operation. For example, the command execution system may compare the inputs within the second privileged command to determine whether those inputs match a specific predetermined privileged operation. In some embodiments, there may be one or more predetermined privileged commands (e.g., a munitions command—to fire a weapon—a destruct command, and/or another suitable command).

When the command execution system determines that the sequence of inputs corresponds to a particular privileged command, the command execution system may transmit that command to the vehicle (e.g., an aerial drone with a mounted weapon). That is, based on determining that the second privileged command corresponds to the second input in the sequence of inputs for executing the privileged operation, the command execution system may transmit a request to the vehicle to perform the privileged operation. For example, the command execution system may transmit a munitions command (e.g., fire a weapon) to an aerial drone.

In some embodiments, the privileged commands may need to be encrypted based on permissions given to the particular mobile device. The command execution system may use a file or another mechanism to determine whether the mobile device has permissions to execute privileged operations. If so, the mobile device will be enabled to encrypt the privileged operation before transmitting the encrypted privileged operation to the vehicle. That is, in some embodiments, the vehicle may only accept encrypted privileged operations.

Various other aspects, features, and advantages of the system will be apparent through the detailed description and the drawings attached hereto. It is also to be understood that both the foregoing general description and the following detailed description are examples and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for a layered fail-safe redundancy for privileged operation execution, in accordance with one or more embodiments of this disclosure.

FIG. 2 illustrates an example mobile device and controller in advance of privileged operation, in accordance with one or more embodiments of this disclosure.

FIG. 3 illustrates an excerpt of a data structure for identifying munitions commands and other privileged commands, in accordance with one or more embodiments of this disclosure.

FIG. 4 illustrates a combination of inputs received from the operator that make up the second privileged command, in accordance with one or more embodiments of this disclosure.

FIG. 5 illustrates how the commands from the vehicle controller may be generated using dedicated hardware, in accordance with one or more embodiments of this disclosure.

FIG. 6 illustrates a computing device, in accordance with one or more embodiments of this disclosure.

FIG. 7 is a flowchart of operations for detecting motion-induced errors received from inertial-type input devices, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

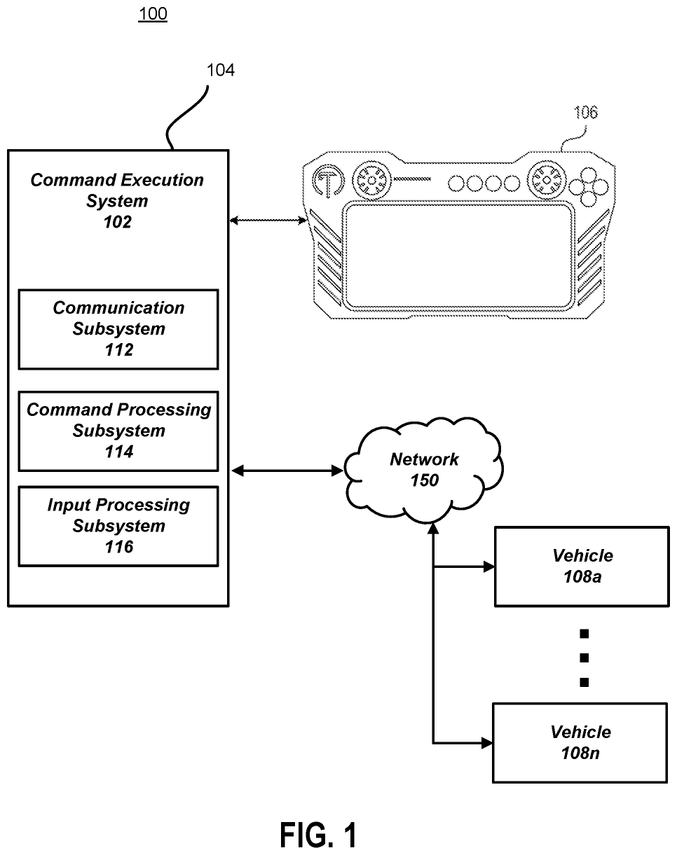

FIG. 1 is an example of environment 100 for a layered fail-safe redundancy system and architecture for privileged operation execution. Environment 100 includes command execution system 102 residing on mobile device 104, vehicle controller 106, and vehicles 108a-108n (e.g., unmanned vehicles). Vehicles 108a-108n may be connected to the mobile device via network 150. Command execution system 102 may execute instructions of the layered fail-safe redundancy system. Command execution system 102 may include software, hardware, firmware, or a combination of the three. For example, command execution system 102 may reside on a mobile device (e.g., a mobile smartphone, an electronic tablet, a computer system, or another suitable mobile device) that uses network 150 to send commands to one or more vehicles (e.g., unmanned vehicles). In some embodiments, one or more components of command execution system 102 may reside on other suitable devices.

Vehicle controller 106 may be a controller device connected to mobile device 104. Vehicle controller 106 may include a plurality of input devices (e.g., buttons, joysticks, switches, levers, etc.). Vehicle controller 106 may receive controller input from an operator. For example, an operation may press buttons and/or use joysticks to control unmanned aerial vehicles. In some embodiments, mobile device 104 may slide into vehicle controller 106. The mobile device and the vehicle controller may be connected via a physical connection (e.g., universal serial bus (USB) connection). The physical connection may be split into two or more channels. In some embodiments, each channel may be created based on a type of interface used by the mobile device. For example, the first channel may correspond to a USB human interface device (HID), which enables user input devices (e.g., keyboards, mice, and/or other controllers) to communicate with the mobile device. The second channel may correspond to a USB communication device class (CDC) serial interface, which is a communication class enabling interfacing with a mobile device using a network-style interface.

In some embodiments, the vehicle controller may be connected with the mobile device over a wireless network connection. For example, the wireless network connection may be a Wireless Fidelity (Wi-Fi) connection or a Bluetooth connection. Other wireless network connections may be used as long as two channels of communication are supported by a wireless connection. In some embodiments, only point-to-point wireless connections may be used.

Network 150 may be a wireless local area network, a wireless wide area network (e.g., the Internet), or a combination of the two. Vehicles 108a-108n may be unmanned vehicles, including aerial vehicles, land vehicles, and/or maritime vehicles. In some embodiments, vehicles may be manned vehicles that may be controlled by the vehicle controller.

Command execution system 102 may receive, from a vehicle controller at a mobile device over a first channel, a vehicle maneuvering command. As discussed above, the mobile device may be connected with the vehicle controller over a physical connection having the first channel and a second channel. The controller may be a vehicle controller that enables an operator to control one or more vehicles (e.g., unmanned vehicles).

In some embodiments, command execution system 102 may receive the vehicle maneuvering command using communication subsystem 112. Communication subsystem 112 may include software components, hardware components, or a combination of both. For example, communication subsystem 112 may include a USB adapter that is coupled with software to drive the adapter. The USB adapter may be built into the mobile device hosting the command execution system 102. Communication subsystem 112 may receive the maneuvering command from vehicle controller 106. In some embodiments, communication subsystem 112 may receive the vehicle maneuvering command over a USB HID interface corresponding to the first channel. That is, vehicle controller 106 may be connected to the mobile device as a human interface device.

In some embodiments, communication subsystem 112 may receive a vehicle maneuvering request over a wireless connection that supports multiple channels. For example, communication subsystem 112 may include a network controller and/or a Bluetooth controller. Thus, communication subsystem 112 may be connected with the vehicle controller using a point-to-point Wi-Fi connection and/or a point-to-point Bluetooth connection. In some embodiments, each connection may allow multiple connecting channels. In some embodiments, the first channel may be a Wi-Fi connection while the second channel may be a Bluetooth connection or vice versa.

The vehicle maneuvering command may be an interaction of an operator with one or more joysticks, one or more buttons, etc. Communication subsystem 112 may pass the maneuvering command or a pointer to the maneuvering command in memory to command processing subsystem 114.

Command processing subsystem 114 may include software components, hardware components, or a combination of both. For example, command processing subsystem 114 may include software components that access data in memory and/or storage and may use one or more processors to perform its operations. Command processing subsystem 114 may receive the maneuvering command, perform required processing, and then transmit the maneuvering command to a vehicle (e.g., an unmanned vehicle). For example, the maneuvering command may be a command to an unmanned aerial vehicle to proceed forward. Thus, command processing subsystem 114 may use communication subsystem 112 to transmit the command (e.g., over network 150) to one or more vehicles 108a-108n. Command execution system 102 may continue receiving maneuvering commands, processing those commands, and transmitting those commands to one or more vehicles (e.g., unmanned vehicles).

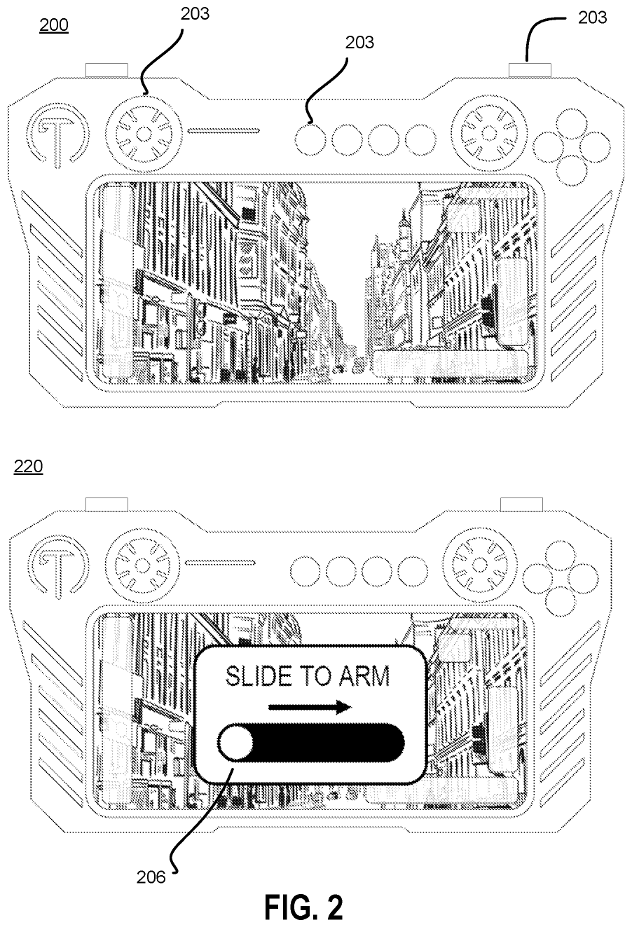

Command execution system 102 may receive (e.g., via communication subsystem 112), using an input mechanism associated with the mobile device, a first privileged command. For example, FIG. 2 illustrates an example mobile device and controller in advance of privileged operation. As shown in FIG. 2, system 200 and system 220 illustrate a combination of the mobile device and the vehicle controller. The mobile device is illustrated as slid into the vehicle controller (e.g., vehicle controller 106). Vehicle controller 106 may include a plurality of actuators 203 (e.g., buttons, joysticks, etc.) for receiving input from an operator. As discussed above, the mobile device may receive inputs (e.g., over the USB connection) enabling the vehicle controller to control a vehicle (e.g., an unmanned vehicle) via the mobile device (e.g., mobile device 104). The mobile device may include a touch screen interface or another type of interface. When an operator wants to initiate a privileged command, the operator may actuate an input device on the vehicle controller. The vehicle controller may signal to the mobile device (e.g., via USB HID interface) over the first channel that a privileged operation has been requested. In response, the mobile device may generate for display a prompt 206. The input mechanism may be a touch screen on the mobile device. The mobile device may receive the input as the first privileged command.

In some embodiments, command execution system 102 may receive, using the input mechanism associated with the mobile device, a first munitions command. The first munitions command may be an initiation of a firing command for firing a weapon mounted on board an unmanned vehicle. As shown in FIG. 2, the first munitions command may be an operator performing a gesture input on prompt 206. When the gesture (e.g., sliding a finger across the slider) is finished, the mobile device may interpret the gesture as a first munitions command or, more generally, a first privileged command. As discussed above, the privileged operation does not have to involve a munitions command. The first privileged command (e.g., the first munitions command) may be a part of a privileged operation (e.g., a munitions operation).

When the first privileged command is received, it may be processed by input processing subsystem 116. Input processing subsystem 116 may include software components, hardware components, or a combination of both. For example, input processing subsystem 116 may include software components that access data in memory and/or storage and may use one or more processors to perform its operations. That is, based on receiving the first privileged command, input processing subsystem 116 may initiate a privileged mode of operation. The privileged mode of operation may enable privileged operations using the vehicle controller. For example, input processing subsystem 116 may signal to command execution system 102 that further privileged commands are anticipated from the vehicle controller over a second channel. In some embodiments, input processing subsystem 116 may signal to command processing subsystem 114 to initiate monitoring of the second channel. For example, as described above, the second channel may be a USB CDC serial interface. Thus, command processing subsystem 114 may start monitoring that interface for further commands from the vehicle controller.

As discussed above, in some embodiments, the mobile device may be connected to the vehicle controller via one or more wireless connections (e.g., Wi-Fi and/or Bluetooth). In these embodiments, command execution system 102 may communicate (e.g., via communication subsystem 112) with the vehicle controller over a single channel (e.g., one Wi-Fi channel or one Bluetooth channel). When the first privileged command is received, command execution system may establish (e.g., via communication subsystem 112) a second channel (e.g., a second Wi-Fi channel or a second Bluetooth channel) for communicating with the vehicle controller. In some embodiments, a first channel may be a Wi-Fi channel, and the second channel may be a Bluetooth channel or vice versa.

As discussed above, in some embodiments, the privileged command may be a munitions command for firing a weapon on board the vehicle (e.g., an unmanned vehicle). Thus, input processing subsystem 116 may determine that the first munitions command corresponds to a first input in a sequence of inputs for executing a munitions operation. For example, when input processing subsystem 116 receives the operator input (e.g., gesture via a slider associated with prompt 206), input processing subsystem 116 may compare the input (e.g., combination of prompt and gesture) with predetermined commands. For example, the prompt may indicate “arm,” and the gesture may indicate “completed.” Thus, the input may indicate “arm completed.” This indication may be compared with pre-stored commands. Thus, based on determining that the input matches a first command in a sequence of predetermined commands, input processing subsystem 116 may determine that the input sequence has been initiated.

Once command execution system 102 (e.g., via input processing subsystem 116) determines that a munitions command (or another suitable privileged command) has been received, command execution system 102 (e.g., via command processing subsystem 114) may initiate the privileged mode of operation. This may include monitoring the second channel for other munitions commands (e.g., firing commands, destruct commands, etc.). In some embodiments, based on determining that the first munitions command corresponds to the first input in the sequence of inputs for executing the munitions operation, command execution system 102 (e.g., via command processing subsystem 114) may monitor the second channel for a second munitions command from the vehicle controller.

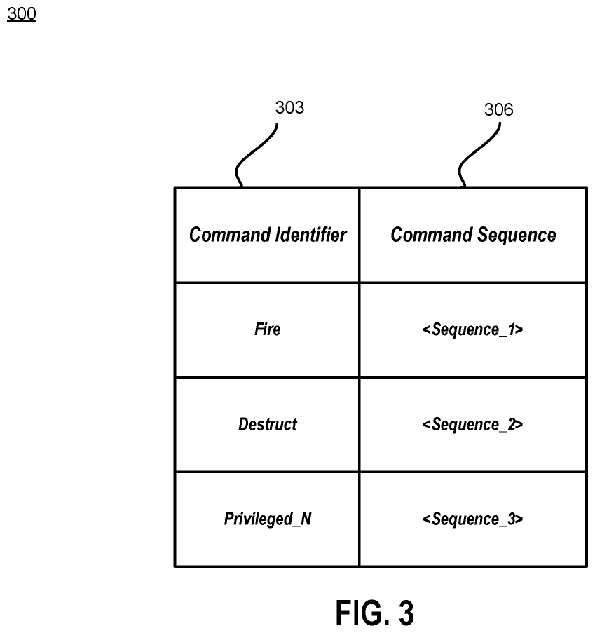

FIG. 3 illustrates an excerpt of a data structure 300 for identifying munitions commands and other privileged commands. Name fields 303 may store command identifiers, and value fields 306 may store corresponding command sequences. Thus, when input processing subsystem 116 detects an input on the mobile device, input processing subsystem 116 may compare the input with a first command within each sequence to determine whether a particular sequence is to be initiated (e.g., a firing sequence). In some embodiments, the sequence initiation may be the same for all privileged commands. Thus, the comparison in sequences may occur when the “second privileged command” is received.

Command processing subsystem 114 may detect a command from the vehicle controller over the second channel and process that command. Command processing subsystem 114 may determine that the received command is another privileged command. For example, while command execution system 102 is in privileged mode of operation, a command from the vehicle controller may be received over the second channel. As discussed above, the second channel may be a USB CDC serial interface in a wired environment. In another example, in wireless environments, the command may be received over a second Wi-Fi channel, a second Bluetooth channel, etc. When the command is received, command processing subsystem 114 may determine that the received command is a second privileged command by, for example, comparing the command with command sequences illustrated in FIG. 3. If the command matches one or more of the command sequences, command processing subsystem 114 may determine that the command is the second privileged command. Thus, command processing subsystem 114 may receive a second privileged command from the vehicle controller over the second channel. As discussed above, the second privileged command may be a munitions command, for example, for firing a weapon mounted onto a vehicle.

In some embodiments, command processing subsystem 114 may only accept privileged commands for a predetermined amount of time before the privileged mode is deactivated. This enables preventing accidental execution when an operator mistakes the privileged mode of operation for a regular mode of operation. In particular, command processing subsystem 114 may determine that the second privileged command has not been received within a predetermined threshold of time. For example, when the privileged mode is activated, command processing subsystem 114 may start a timer and/or generate a timestamp indicating a time when the privileged mode has been activated. Command processing subsystem 114 may then determine (e.g., based on the timer or the timestamp) when a predetermined time (e.g., 10 seconds, 30 seconds, 1 minute, etc.) has expired.

Once the time has expired, command processing subsystem 114 may perform particular actions related to disabling privileged mode. Thus, based on determining that the second privileged command has not been received within the predetermined threshold of time, command processing subsystem 114 may stop monitoring the second channel. For example, command processing subsystem 114 may ignore any commands detected from the second channel. In some embodiments, command processing subsystem 114 may inform the operator that privileged mode has been disabled due to an expired timer. For example, command execution system 102 may generate for display on the mobile device an indication that privileged mode has been disabled. Additionally or alternatively, command execution system 102 (e.g., via command processing subsystem 114) may generate for display, on the mobile device, a prompt to execute the first privileged command. For example, command execution system 102 may generate for display prompt 206 of FIG. 2.

When a command is received while the device is in privileged mode, command execution system 102 may (e.g., via command processing subsystem 114) determine whether the command is one of the commands in a sequence for executing a privileged operation (e.g., a munitions operation such as firing a weapon). In particular, command processing subsystem 114 may determine whether the second privileged command corresponds to a second input in a sequence of inputs for executing a privileged operation. For example, command processing subsystem 114 may compare the received command with commands in value fields 306 to determine whether the received command is one of the commands for a particular privileged operation. In some embodiments, command processing subsystem 114 may compare both the first privileged command and the second privileged command to the command sequence to determine whether the combination matches a particular command sequence.

As discussed above, each command sequence of FIG. 3 (each field of value fields 306) may include two or more commands that together form a privileged operation. For example, command processing subsystem 114 may determine whether the second munitions command corresponds to a second input in the sequence of inputs for executing the munitions operation. That is, a particular munitions command may be identified as part of a privilege or munitions operation. For example, as shown in FIG. 3, one of the privileged operations (e.g., a munitions command) may be a “fire” operation (e.g., instructing a vehicle to fire its weapon). If the second munitions command matches the “fire” operation or a combination of the first munitions command and the second munitions command matches the “fire” operation, command processing subsystem 114 may identify that the desired operation is a “fire” operation and perform processing to instruct the vehicle to fire its weapon.

In some embodiments, command execution system 102 may use the following operations to determine whether the second privileged command corresponds to the second input in the sequence of inputs for executing the privileged operation. In particular, command execution system 102 may determine whether the privileged mode of operation has been initiated. For example, when the first privileged command is received, command execution system 102 may set a flag, for example, in memory indicating that the privileged mode of operation has been initiated. Once the privileged mode is initiated, command execution system 102 may receive one or more commands over the second channel.

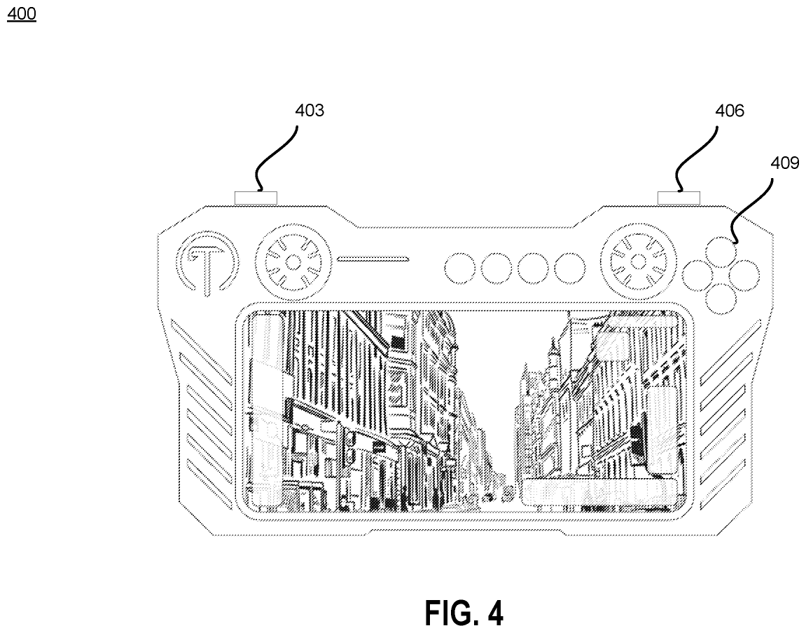

Command execution system 102 may determine, based on the second privileged command received via the second channel, whether a plurality of inputs within the second privileged command match the privileged operation. FIG. 4 illustrates a vehicle controller 400 showing a combination of inputs received from the operator that make up the second privileged command. For example, the second privileged command may include a combination of button 403 and button 406 being pressed and then pressing button 409 while button 403 and button 406 are pressed. In some embodiments, the second privileged command may include multiple commands. For example, the combination of pressing button 403 and button 406 may be one part of the privileged command (e.g., in a sequence of inputs for a munitions command), and pressing button 409 in combination with button 403 and button 406 may be another part of the privileged command. Thus, the privileged command may have multiple sub-commands, which may be used as a comparison with the command sequence as, for example, shown in FIG. 3.

Command execution system 102 may then determine that the second privileged command corresponds to the second input in the sequence of inputs based on both determining (1) that the privileged mode of operation has been initiated and (2) that the plurality of inputs within the second privileged command match the privileged operation. In some embodiments, command execution system 102 may first determine that privileged mode has been initiated and then also determine that the plurality of inputs correspond to the second privileged command (e.g., the first privileged command in combination with the second privileged command (or sub-commands)). In some embodiments, those determinations may be made in parallel.

In some embodiments, command execution system 102 may use the following operations to determine that the second privileged command corresponds to the second input in the sequence of inputs for executing the privileged operation. Command execution system 102 may receive, from the vehicle controller over the second channel, a plurality of signals indicating that a combination of input devices has been actuated. For example, the signals may be received over a USB CDC serial interface. In some embodiments, the signals may be received over a second wireless channel, as described above. The signals may correspond to a button press or combinations of button presses. For example, the operator may press button 403 and button 406 on the vehicle controller together. The vehicle controller may transmit those button presses over the second channel to the mobile device.

The operator may press button 409 while holding button 403 and button 406. Thus, the mobile device may receive, from the vehicle controller over the second channel while the combination of the input devices is being actuated, an additional signal indicating that an additional input device has been actuated. The additional signal may indicate that both the combination of the input devices and the additional input device have been actuated.

Command execution system 102 may then determine that the combination of the input devices being actuated corresponds to a first portion of the sequence of inputs and that the additional input device being actuated together with the combination of the input devices corresponds to a second portion of the sequence of inputs. As described in this disclosure, the second privileged command may include sub-commands that may be used to identify the matching privileged operation (e.g., munitions operation). Once the match is determined, command execution system 102 may generate one or more instructions that make up the privileged operation.

In some embodiments, only one privileged operation (e.g., munitions operation) may be allowed per privileged mode activation. Thus, command execution system 102 may determine that the combination of the input devices is no longer being actuated (e.g., the operator let go of the buttons), and based on determining that the combination of the input devices is no longer being actuated, command execution system 102 may disengage/disable the privileged mode of operation. For example, in these embodiments, once the firing command has been sent to the vehicle, to send another privileged command, privileged mode of operation will need to be restarted.

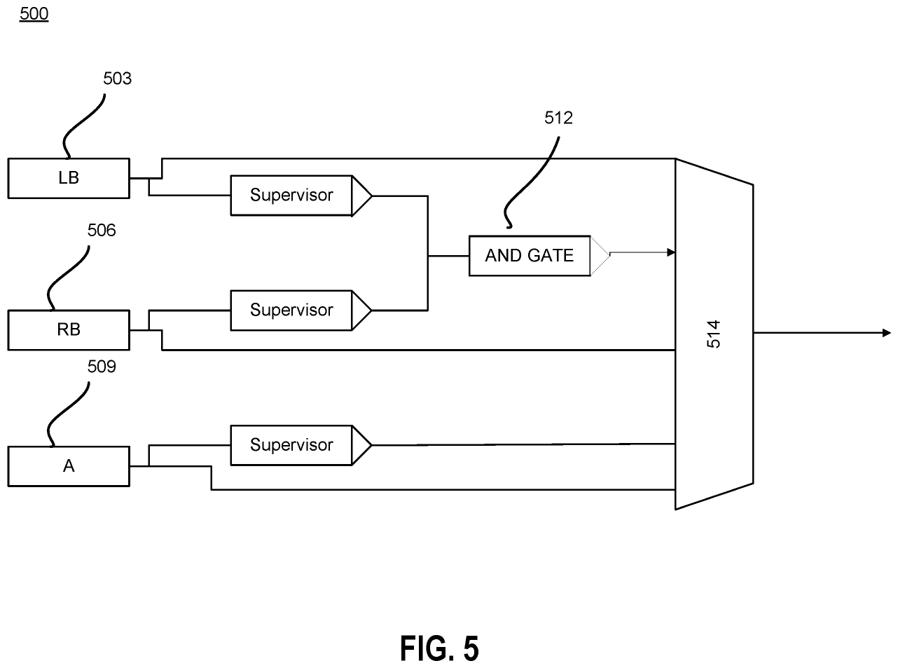

Command execution system 102 may receive, from the vehicle controller, one or more inputs received from the operator. FIG. 5 illustrates how the commands from the vehicle controller may be generated using dedicated hardware. FIG. 5 shows a high-reliability circuitry 500 device to ensure that positive activation of button presses occurs to instruct the electronic arming/disarming and “go-live” button presses. Circuitry 500 was designed to mitigate spurious transients, button debouncing circuit coupling, user button variability, button failures, and other issues. Input device 503 may be triggered by the operator pressing button 403 (FIG. 4), while input device 506 may be triggered by the operator pressing button 406 (FIG. 4). Each input device may be coupled with a supervisor designed to ensure proper operation during privileged mode of operation. During normal operation, supervisors may not be necessary. In addition, input device 503 and input device 506 are connected to an AND GATE 512, which enables efficient operation of simultaneous presses. Input device 509 may be activated by the operator pressing button 409 (FIG. 4). A special hardware device 514 receives all the input signals and sends them to the mobile device (e.g., over the second channel if in privileged mode of operation and over the first channel during normal mode of operation).

When command execution system 102 determines that the second privileged command or the combination of the first privileged command and the second privileged command matches the privileged operation, command execution system 102 may cause a vehicle (e.g., an unmanned vehicle) to execute the command. Thus, based on determining that the second privileged command corresponds to the second input in the sequence of inputs for executing the privileged operation, command execution system 102 may transmit a request to the vehicle to perform the privileged operation. For example, command processing subsystem 114 may identify the privileged operation based on the second privileged command or based on the combination of the first privileged command and the second privileged command. In some embodiments, command processing subsystem 114 may use the data structure in FIG. 3 to perform identification. For example, command processing subsystem 114 may match a command sequence in value fields 306 with the second privileged command or a combination of the first privileged command and the second privileged command. As described above, the privileged operation may be a munitions operation. Accordingly, command processing subsystem 114 may, based on determining that the second munitions command corresponds to the second input in the sequence of inputs for executing the munitions operation, transmit a request to the unmanned vehicle to perform the munitions operation.

In some embodiments, before executing the privileged operation, command processing subsystem 114 may determine whether the mobile device has permissions/privileges to execute the privileged command. For example, the mobile device may need a particular government license to execute the privileged commands. Thus, command processing subsystem 114 may, based on receiving the second privileged command, determine, based on a privilege file, whether the mobile device is allowed to execute the privileged operation. For example, the government license may be the privilege file that includes data (e.g., a code) for determining whether the mobile device has permissions to execute privileged operations and/or enter privileged mode. In some embodiments, the privilege file may include data to encrypt the privileged command before sending that command to the vehicle, such that the vehicle may only execute privileged commands encrypted using the right data (e.g., the correct key, which may be stored in the privilege file). Accordingly, based on determining that the mobile device is allowed to execute the privileged operation, command processing subsystem 114 may generate an encrypted privileged operation by encrypting the privileged operation using an encryption function (e.g., an encryption function using a key from the privilege file). In some embodiments, the privilege file may include an API for generating encrypted privileged commands to be sent to the vehicle. Once the privileged operation is encrypted, command execution system 102 may transmit (e.g., via communication subsystem 112) the encrypted privileged command to the vehicle.

In some embodiments, command processing subsystem 114 may determine that the second privileged command or the combination of the first privileged command and the second privileged command does not match a privileged operation. For example, the second privileged command or the combination of the first privileged command and the second privileged command does not match any command sequence in value fields 306. Thus, command execution system 102 may (e.g., using command processing subsystem 114) determine that the second privileged command does not correspond to the second input in the sequence of inputs for executing the privileged operation. As discussed above, based on determining that the second privileged command does not correspond to the second input in the sequence of inputs for executing the privileged operation, command processing subsystem 114 may stop monitoring the second channel. Alternatively or additionally, command processing subsystem 114 may disable the privileged mode and put the system (e.g., the mobile device and the vehicle controller) into a regular mode for executing maneuvering and other types of commands.

In some embodiments, command processing subsystem 114 may prompt the user to reinitiate the privileged mode of operation. In particular, command processing subsystem 114 may determine that the sequence of inputs for executing the privileged operation has been broken. For example, if command processing subsystem 114 determines that a command has been received that does not match a command in a sequence for a privileged operation, command processing subsystem 114 may determine that the privileged operation has been broken. In another example, if command processing subsystem 114 determines that a combination of a first privileged command and the second privileged command does not match a command in a sequence for a privileged operation, command processing subsystem 114 may determine that the privileged operation has been broken.

Based on determining that the sequence of inputs for executing the privileged operation has been broken, command processing subsystem 114 may prompt a user to execute the first privileged command again using the input mechanism associated with the mobile device. For example, command processing subsystem 114 may generate prompt 206 (e.g., a slider) for display. In some embodiments, command processing subsystem 114 may generate for display another interactive image for receiving input of reengaging the privileged mode.

### Computing Environment

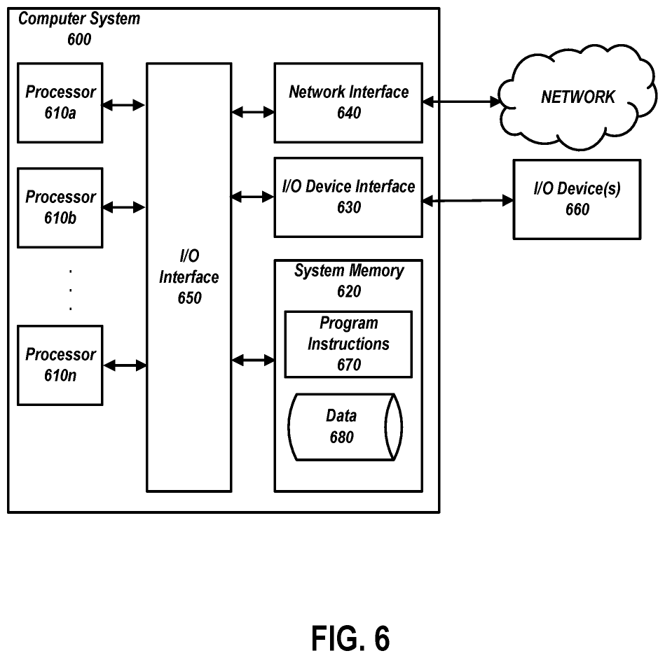

FIG. 6 shows an example computing system that may be used in accordance with some embodiments of this disclosure. In some instances, computing system 600 is referred to as a computer system. The computing system may be part of mobile device 104. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uniprocessor system including one processor (e.g., processor 610a) or a multiprocessor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the peripheral component interconnect (PCI) bus standard or the universal serial bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components or distributed in additional components. Similarly, in some embodiments, the functionality of some of the illustrated components may not be provided, or other additional functionality may be available.

### Operation Flow

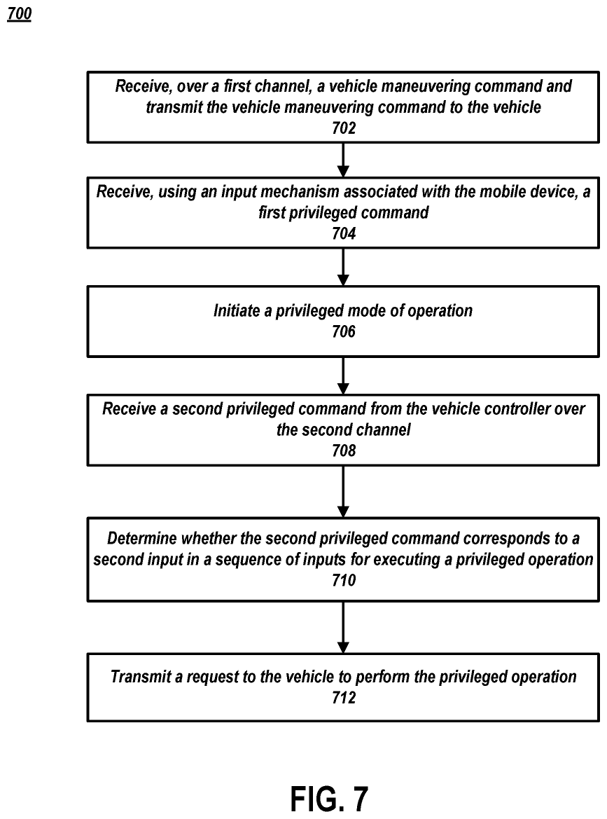

FIG. 7 is a flowchart 700 of operations detecting motion-induced errors received from inertial-type input devices. The operations of FIG. 7 may use components described in relation to FIG. 6. In some embodiments, command execution system 102 may include one or more components of computing system 600. At 702, command execution system 102 receives, over a first channel, a vehicle maneuvering command and transmits the vehicle maneuvering command to the vehicle. Command execution system 102 may receive the vehicle maneuvering command via I/O device(s) 660 (over a wired USB connection) through I/O device interface 630 or over a point-to-point wireless connection using network interface 640. Command execution system 102 may transmit the maneuvering command to the vehicle using network interface 640 through network 150.

At 704, command execution system 102 receives, using an input mechanism associated with the mobile device, a first privileged command. Command execution system 102 may use one or more I/O device(s) 660 through I/O device interface 630 to receive the first privileged command. At 706, command execution system 102 initiates a privileged mode of operation. Command execution system 102 may use one or more processors 610a, 610b, and/or 610n to perform the generation.

At 708, command execution system 102 receives a second privileged command from the vehicle controller over the second channel. Command execution system 102 may receive the second privileged command over a second channel of I/O device(s) 660 (e.g., over a wired USB connection) through I/O device interface 630 or over a second channel of a point-to-point wireless connection using network interface 640. At 710, command execution system 102 determines whether the second privileged command corresponds to a second input in a sequence of inputs for executing a privileged operation. Command execution system 102 may use one or more processors 610a, 610b, and/or 610n to perform the determination. At 712, command execution system 102 transmits a request to the vehicle to perform the privileged operation. Command execution system 102 may transmit the request to the vehicle using network interface 640 through network 150.

Although the present invention has been described in detail for the purpose of illustration based on what is currently considered to be the most practical and preferred embodiments, it is to be understood that such detail is solely for that purpose and that the invention is not limited to the disclosed embodiments but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: receiving, from a vehicle controller at a mobile device over a first channel, a vehicle maneuvering command, wherein the mobile device is connected with the vehicle controller over a physical connection having the first channel and a second channel; transmitting the vehicle maneuvering command to a vehicle; receiving, using an input mechanism associated with the mobile device, a first privileged command; based on receiving the first privileged command, initiating a privileged mode of operation, wherein the privileged mode of operation enables privileged operations using the vehicle controller; receiving a second privileged command from the vehicle controller over the second channel; determining whether the second privileged command corresponds to a second input in a sequence of inputs for executing a privileged operation; and based on determining that the second privileged command corresponds to the second input in the sequence of inputs for executing the privileged operation, transmitting a request to the vehicle to perform the privileged operation.

2. Any of the preceding embodiments, further comprising: determining that the second privileged command has not been received within a predetermined threshold of time; and based on determining that the second privileged command has not been received within the predetermined threshold of time: stopping monitoring the second channel; and generating for display, on the mobile device, a prompt to execute the first privileged command.

3. Any of the preceding embodiments, further comprising: determining that the second privileged command does not correspond to the second input in the sequence of inputs for executing the privileged operation; and based on determining that the second privileged command does not correspond to the second input in the sequence of inputs for executing the privileged operation, stopping monitoring the second channel.

4. Any of the preceding embodiments, further comprising: determining that the sequence of inputs for executing the privileged operation has been broken; and based on determining that the sequence of inputs for executing the privileged operation has been broken, prompting a user to execute the first privileged command again using the input mechanism associated with the mobile device.

5. Any of the preceding embodiments, wherein: receiving the vehicle maneuvering command comprises receiving the vehicle maneuvering command over a universal serial bus human interface devices interface; and receiving, the second privileged command comprises, receiving the second privileged command over a universal serial bus communications device class interface.

6. Any of the proceeding embodiments, further comprising: based on receiving the second privileged command, determining, based on a privilege file, whether the mobile device is allowed to execute the privileged operation; and based on determining that the mobile device is allowed to execute the privileged operation, generating an encrypted privileged operation by encrypting the privileged operation using an encryption function.

7. Any of the preceding embodiments, wherein transmitting the request to the vehicle to perform the privileged operation comprises transmitting the encrypted privileged operation.

8. Any of the preceding embodiments, wherein initiating the privileged mode of operation further comprises, based on receiving the first privileged command, monitoring the second channel for the second privileged command from the vehicle controller.

9. Any of the preceding embodiments, wherein determining whether the second privileged command corresponds to the second input in the sequence of inputs for executing the privileged operation further comprises: determining whether the privileged mode of operation has been initiated; determining, based on the second privileged command received via the second channel, whether a plurality of inputs within the second privileged command match the privileged operation; and determining that the second privileged command corresponds to the second input in the sequence of inputs based on both determining (1) that the privileged mode of operation has been initiated and (2) that the plurality of inputs within the second privileged command match the privileged operation.

10. Any of the preceding embodiments, wherein determining that the second privileged command corresponds to the second input in the sequence of inputs for executing the privileged operation further comprises: receiving, from the vehicle controller over the second channel, a plurality of signals indicating that a combination of input devices has been actuated; receiving, from the vehicle controller over the second channel while the combination of the input devices is being actuated, an additional signal indicating that an additional input device has been actuated, wherein the additional signal indicates that both the combination of the input devices and the additional input device have been actuated; determining that the combination of the input devices being actuated corresponds to a first portion of the sequence of inputs and that the additional input device being actuated together with the combination of the input devices corresponds to a second portion of the sequence of inputs; and generating one or more instructions comprising the privileged operation.

11. Any of the preceding embodiments, further comprising: determining that the combination of the input devices is no longer being actuated; and based on determining that the combination of the input devices is no longer being actuated, disengaging the privileged mode of operation.

12. A tangible, non-transitory, machine-readable medium storing instructions that, when executed by a data processing apparatus, cause the data processing apparatus to perform operations comprising those of any of embodiments 1-11.

13. A system comprising: one or more processors; and memory storing instructions that, when executed by the processors, cause the processors to effectuate operations comprising those of any of embodiments 1-11.

14. A system comprising means for performing any of embodiments 1-11.

15. A system comprising cloud-based circuitry for performing any of embodiments 1-11.

What is claimed is:

1. A system for providing fail-safe redundancy via single data bus, the system comprising:
a vehicle controller comprising a plurality of input devices, wherein the vehicle controller receives controller input from an operator; and
a mobile device connected with the vehicle controller over a universal serial bus connection having a first channel connected using a first interface and a second channel connected using a second interface, wherein the mobile device wirelessly transmits commands to an unmanned vehicle, the mobile device comprising:
one or more processors; and
one or more non-transitory, computer-readable storage media storing instructions, which when executed by the one or more processors cause the one or more processors to perform operations comprising:
receiving, from the vehicle controller over the first channel, a vehicle maneuvering command for maneuvering the unmanned vehicle;
transmitting the vehicle maneuvering command to the unmanned vehicle;
receiving, using an input mechanism associated with the mobile device, a first privileged command;
determining that the first privileged command corresponds to a first input in a sequence of inputs for executing a privileged operation;
based on determining that the first privileged command corresponds to the first input in the sequence of inputs for executing the privileged operation, monitoring the second channel for a second privileged command from the vehicle controller;
receiving the second privileged command from the vehicle controller over the second channel;
determining whether the second privileged command corresponds to a second input in the sequence of inputs for executing the privileged operation; and
based on determining that the second privileged command corresponds to the second input in the sequence of inputs for executing the privileged operation, transmitting a request to the unmanned vehicle to perform the privileged operation.

2. A method for providing fail-safe redundancy via single data bus, the method comprising:
receiving, from a vehicle controller at a mobile device over a first channel, a vehicle maneuvering command, wherein the mobile device is connected with the vehicle controller over a physical connection having the first channel and a second channel;
transmitting the vehicle maneuvering command to a vehicle;
receiving, using an input mechanism associated with the mobile device, a first privileged command;
based on receiving the first privileged command, initiating a privileged mode of operation, wherein the privileged mode of operation enables privileged operations using the vehicle controller;
receiving a second privileged command from the vehicle controller over the second channel;
determining whether the second privileged command corresponds to a second input in a sequence of inputs for executing a privileged operation; and
based on determining that the second privileged command corresponds to the second input in the sequence of inputs for executing the privileged operation, transmitting a request to the vehicle to perform the privileged operation.

3. The method of claim 2, further comprising:
determining that the second privileged command has not been received within a predetermined threshold of time; and
based on determining that the second privileged command has not been received within the predetermined threshold of time:
stopping monitoring the second channel; and
generating for display, on the mobile device, a prompt to execute the first privileged command.

4. The method of claim 2, further comprising:
determining that the second privileged command does not correspond to the second input in the sequence of inputs for executing the privileged operation; and
based on determining that the second privileged command does not correspond to the second input in the sequence of inputs for executing the privileged operation, stopping monitoring the second channel.

5. The method of claim 2, further comprising:
determining that the sequence of inputs for executing the privileged operation has been broken; and
based on determining that the sequence of inputs for executing the privileged operation has been broken, prompting a user to execute the first privileged command again using the input mechanism associated with the mobile device.

6. The method of claim 2, wherein:
receiving the vehicle maneuvering command comprises receiving the vehicle maneuvering command over a universal serial bus human interface devices interface; and
receiving, the second privileged command comprises, receiving the second privileged command over a universal serial bus communications device class interface.

7. The method of claim 2, further comprising:
based on receiving the second privileged command, determining, based on a privilege file, whether the mobile device is allowed to execute the privileged operation; and
based on determining that the mobile device is allowed to execute the privileged operation, generating an encrypted privileged operation by encrypting the privileged operation using an encryption function.

8. The method of claim 7, wherein transmitting the request to the vehicle to perform the privileged operation comprises transmitting the encrypted privileged operation.

9. The method of claim 2, wherein initiating the privileged mode of operation further comprises, based on receiving the first privileged command, monitoring the second channel for the second privileged command from the vehicle controller.

10. The method of claim 2, wherein determining whether the second privileged command corresponds to the second input in the sequence of inputs for executing the privileged operation further comprises:
determining whether the privileged mode of operation has been initiated;
determining, based on the second privileged command received via the second channel, whether a plurality of inputs within the second privileged command match the privileged operation; and
determining that the second privileged command corresponds to the second input in the sequence of inputs based on both determining (1) that the privileged mode of operation has been initiated and (2) that the plurality of inputs within the second privileged command match the privileged operation.

11. The method of claim 2, wherein determining that the second privileged command corresponds to the second input in the sequence of inputs for executing the privileged operation further comprises:
receiving, from the vehicle controller over the second channel, a plurality of signals indicating that a combination of input devices has been actuated;
receiving, from the vehicle controller over the second channel while the combination of the input devices is being actuated, an additional signal indicating that an additional input device has been actuated, wherein the additional signal indicates that both the combination of the input devices and the additional input device have been actuated;
determining that the combination of the input devices being actuated corresponds to a first portion of the sequence of inputs and that the additional input device being actuated together with the combination of the input devices corresponds to a second portion of the sequence of inputs; and
generating one or more instructions comprising the privileged operation.

12. The method of claim 11, further comprising:
determining that the combination of the input devices is no longer being actuated; and
based on determining that the combination of the input devices is no longer being actuated, disengaging the privileged mode of operation.

13. One or more non-transitory, computer-readable media comprising instructions for detecting motion-induced errors received from inertial-type input devices that, when executed by one or more processors, cause the one or more processors to perform operations comprising:
receiving, from a vehicle controller at a mobile device over a first channel, a vehicle maneuvering command, wherein the mobile device is connected with the vehicle controller over a physical connection having the first channel and a second channel;
transmitting the vehicle maneuvering command to a vehicle;
receiving, using an input mechanism associated with the mobile device, a first privileged command;
based on receiving the first privileged command, initiating a privileged mode of operation, wherein the privileged mode of operation enables privileged operations using the vehicle controller;
receiving a second privileged command from the vehicle controller over the second channel;
determining that the second privileged command corresponds to a second input in a sequence of inputs for executing a privileged operation; and
based on determining that the second privileged command corresponds to the second input in the sequence of inputs for executing the privileged operation, transmitting a request to the vehicle to perform the privileged operation.

14. The one or more non-transitory, computer-readable media of claim 13, wherein the instructions further cause the one or more processors to:
determine that the second privileged command has not been received within a predetermined threshold of time; and
based on determining that the second privileged command has not been received within the predetermined threshold of time:
stop monitoring the second channel; and
generate for display, on the mobile device, a prompt to execute the first privileged command.

15. The one or more non-transitory, computer-readable media of claim 13, wherein the instructions further cause the one or more processors to:
determine that the second privileged command does not correspond to the second input in the sequence of inputs for executing the privileged operation; and
based on determining that the second privileged command does not correspond to the second input in the sequence of inputs for executing the privileged operation, stop monitoring the second channel.

16. The one or more non-transitory, computer-readable media of claim 13, wherein the instructions further cause the one or more processors to:
determine that the sequence of inputs for executing the privileged operation has been broken; and
based on determining that the sequence of inputs for executing the privileged operation has been broken, prompt a user to execute the first privileged command again using the input mechanism associated with the mobile device.

17. The one or more non-transitory, computer-readable media of claim 13, wherein the instructions further cause the one or more processors to:
receive the vehicle maneuvering command comprises receiving the vehicle maneuvering command over a universal serial bus human interface devices interface; and
receive, the second privileged command comprises, receiving the second privileged command over a universal serial bus communications device class interface.

18. The one or more non-transitory, computer-readable media of claim 13, wherein the instructions further cause the one or more processors to:
based on receiving the second privileged command, determine, based on a privilege file, whether the mobile device is allowed to execute the privileged operation; and
based on determining that the mobile device is allowed to execute the privileged operation, generate an encrypted privileged operation by encrypting the privileged operation using an encryption function.

19. The one or more non-transitory, computer-readable media of claim 18, wherein the instructions for transmitting the request to the vehicle to perform the privileged operation further cause the one or more processors to transmit the encrypted privileged operation.

20. The one or more non-transitory, computer-readable media of claim 13, wherein the instructions for initiating the privileged mode of operation further cause the one or more processors, based on receiving the first privileged command, to monitor the second channel for the second privileged command from the vehicle controller.
